(19) United States
(12) Patent Application Publication
(10) Pub. No.: US 2024/0119341 A1
(43) Pub. Date: Apr. 11, 2024

(54) DETERMINING ONLINE CLASSIFIER PERFORMANCE VIA NORMALIZING FLOWS

(71) Applicant: Lemon Inc., Grand Cayman (KY)

(72) Inventors: Xin YANG, Los Angeles, CA (US); Hanlin ZHU, Los Angeles, CA (US); Tianyi LIU, Los Angeles, CA (US); Jiankai SUN, Los Angeles, CA (US); Yuanshun YAO, Los Angeles, CA (US); Aonan ZHANG, Los Angeles, CA (US); Chong WANG, Los Angeles, CA (US)

(21) Appl. No.: 17/953,255

(22) Filed: Sep. 26, 2022

(51) Int. Cl. G06N 20/00

(52) U.S. Cl. CPC G06N 20/00

(57) ABSTRACT

The present disclosure describes techniques for determining performance of a classifier. A first machine learning model and a second machine learning model may be trained by aggregating updates to the first machine learning model and the second machine learning model received from a plurality of client computing devices. A cumulative distribution function (CDF) associated with a distribution of the positive samples in the user data may be estimated using the trained first machine learning model. A probability density function (PDF) associated with a distribution of the negative samples in the user data may be estimated using the trained second machine learning model. An integration-based computation of an area under the receiver operating characteristic curve (AUC) of the classifier may be performed using the PDF and the CDF.

### BACKGROUND

Machine learning models, such as binary classifiers, are increasingly being used across a variety of industries to perform a variety of different tasks. Such tasks may include categorizing data. Improved techniques for evaluating the performance of machine learning models are desirable.

### BRIEF DESCRIPTION OF THE DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 shows an example system that may be used in accordance with the present disclosure.

FIG. 2 shows an example framework for determining classifier performance in accordance with the present disclosure.

FIG. 3 shows an example framework for training a machine learning model in accordance with the present disclosure.

FIG. 4 shows another example framework for training a machine learning model in accordance with the present disclosure.

FIG. 5 shows an example process for determining classifier performance in accordance with the present disclosure.

FIG. 6 shows another example process for determining classifier performance in accordance with the present disclosure.

FIG. 7 shows another example process for determining classifier performance in accordance with the present disclosure.

FIG. 8 shows another example process for determining classifier performance in accordance with the present disclosure.

FIG. 9 shows a graph illustrating how the value of a prediction functions change with respect to time in accordance with the present disclosure.

FIG. 10 shows an example computing device which may be used to perform any of the techniques disclosed herein.

### DETAILED DESCRIPTION OF ILLUSTRATIVE EMBODIMENTS

In machine learning, binary classification is a supervised learning algorithm that categorizes new observations into one of two classes. A receiver operating characteristic (ROC) curve is a graph showing the performance of a binary classification model (e.g., classifier) at all classification thresholds. The area under the ROC curve (AUC) measures the entire two-dimensional area underneath the entire ROC curve. The AUC associated with a classifier may provide an aggregate measure of performance across all possible decision thresholds. For example, AUC may indicate the probability that the classifier ranks a random positive example more highly than a random negative example. Compared to other performance metrics, AUC is desirable because it does not depend on the decision threshold of the classifier, and it works well for imbalanced datasets. Thus, AUC is an important metric for classifier performance evaluation.

However, it may be difficult to determine AUC without accessing or collecting user data. Given a sample space X and the set of training examples (x, y), where x∈X and y∈{0, 1}, the goal may be to learn a classifier ƒ: X→ [symbol] that has good performance. [symbol] is the distribution of positive samples in the set of training examples (e.g., those training examples that are labeled with y=1) and [symbol] is the distribution of negative samples in the set of training examples (e.g., those training examples that are labeled with y=0). The AUC of the classifier ƒ is defined as the following:

AUC(ƒ):= [symbol] [ƒ(x₊)>ƒ(x₋)]. Equation 1

However, in practice, the distributions [symbol] and [symbol] may not be accessible. Thus, it may not be possible to directly solve Equation 1 to obtain the AUC of the classifier ƒ. Instead, the Wilcoxon-Mann-Whitney statistic may be used as an empirical estimation. The Wilcoxon-Mann-Whitney statistic provides that the empirical AUC estimate is given by:

$$\frac{{\sum }_{i = 1}^{{n}_{+}} {\sum }_{j = 1}^{{n}_{-}} {1}_{f ( {x}_{i} ) > f ( {x}_{j}^{′} )}}{{n}_{+} {n}_{-}} , \qquad Equation 2$$

where we have n₊ positive samples x₁, . . . xₙ₊ and n₋ negative samples x₁′, . . . , xₙ₋′.

The standard method of computing AUC involves a central server collecting data (x, y) and using it to compute the value of Equation 2. However, (x, y) may comprise sensitive user data stored on client computing devices (e.g., mobile phones, PCs, tablets, etc.) Data privacy regulations may prohibit the collection of such sensitive user data and/or the sending of such sensitive user data to a central server. Thus, improved techniques for calculating AUC are desirable. In particular, techniques for calculating AUC without collecting sensitive user data are desirable. Described herein are techniques for determining AUC while protecting user data privacy. The techniques described herein comprise three main components: 1) AUC computation based on integration; 2) normalizing flows; and 3) FedAdam. Each of these three components is described below in more detail.

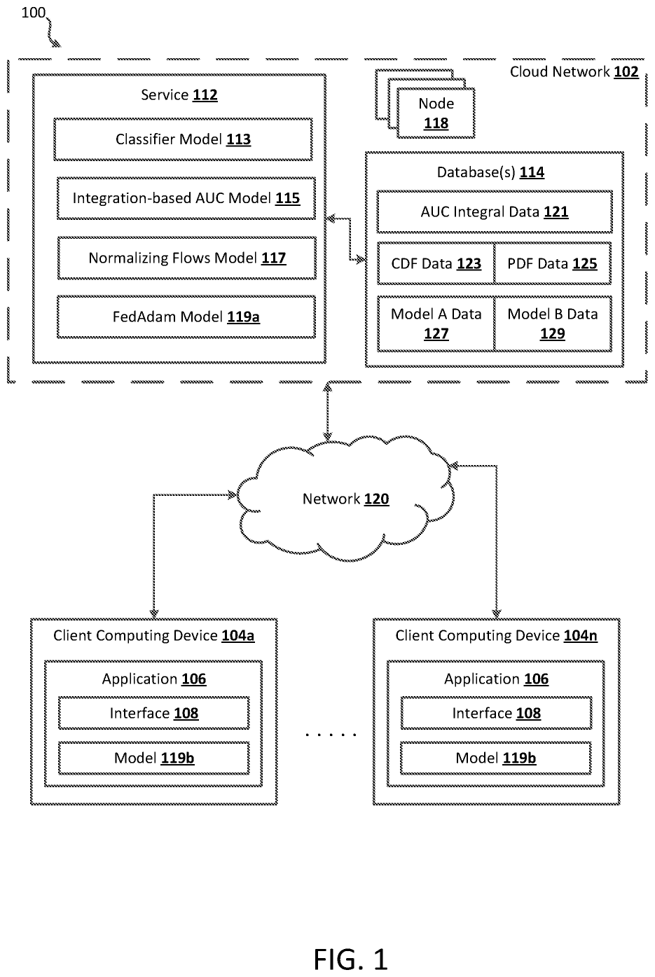

FIG. 1 illustrates an example system 100 that may be used in accordance with the present disclosure. The system 100 may comprise a cloud network 102 and a plurality of client computing devices 104a-n. The cloud network 102 and the plurality of client computing devices 104a-n may communicate with each other via one or more networks 120.

The cloud network 102 may be located at a data center, such as a single premise, or be distributed throughout different geographic locations (e.g., at several premises). The cloud network 102 may provide services via the one or more networks 120. The network 120 may comprise a variety of network devices, such as routers, switches, multiplexers, hubs, modems, bridges, repeaters, firewalls, proxy devices, and/or the like. The network 120 may comprise physical links, such as coaxial cable links, twisted pair cable links, fiber optic links, a combination thereof, and/or the like. The network 120 may comprise wireless links, such as cellular links, satellite links, Wi-Fi links and/or the like.

The cloud network 102 may comprise a plurality of computing nodes 118 that host a variety of services. In an embodiment, the nodes 118 host a service 112. The plurality of computing nodes 118 may process tasks associated with the service 112. The plurality of computing nodes 118 may be implemented as one or more computing devices, one or more processors, one or more virtual computing instances, a combination thereof, and/or the like. The plurality of computing nodes 118 may be implemented by one or more computing devices. The one or more computing devices may comprise virtualized computing instances. The virtualized computing instances may comprise a virtual machine, such as an emulation of a computer system, operating system, server, and/or the like. A virtual machine may be loaded by a computing device based on a virtual image and/or other data defining specific software (e.g., operating systems, specialized applications, servers) for emulation. Different virtual machines may be loaded and/or terminated on the one or more computing devices as the demand for different types of processing services changes. A hypervisor may be implemented to manage the use of different virtual machines on the same computing device.

In an embodiment, the service 112 may be a content service, such as a content streaming service (e.g., an Internet protocol video streaming service). The service 112 may be configured to distribute content via a variety of transmission techniques. The service 112 may be configured to provide the content, such as video, audio, textual data, a combination thereof, and/or the like. The content may comprise content streams (e.g., video stream, audio stream, information stream), content files (e.g., video file, audio file, text file), and/or other data. The content may be stored in a database 114. For example, the service 112 may comprise a video streaming service, a video sharing service, a video hosting platform, a content distribution platform, a collaborative gaming platform, and/or the like.

The content distributed or provided by the service 112 may comprise short videos. The short videos may have a duration less than or equal to a predetermined time limit, such as one minute, five minutes, or other predetermined minutes. By way of example and without limitation, the short videos may comprise at least one, but no more than four, 15 second segments strung together. The short duration of the videos may provide viewers with quick bursts of entertainment that allow users to watch a large quantity of videos in a short time frame. Such quick bursts of entertainment may be popular on social media platforms.

In an embodiment, the content may be output to different client computing devices 104a-n via the network 120. The content may be streamed to the client computing devices 104a-n. The plurality of client computing devices 104a-n may be configured to access the content from the service 112. In an embodiment, a client computing device 104a-n may comprise an application 106. The application 106 may output (e.g., display, render, present) the content to a user associated with the client computing device 104a-n. The content may comprise videos, audio, comments, textual data and/or the like.

The plurality of client computing devices 104a-n may comprise any type of computing device, such as a mobile device, a tablet device, laptop, a desktop computer, a smart television or other smart device (e.g., smart watch, smart speaker, smart glasses, smart helmet), a gaming device, a set top box, digital streaming device, robot, and/or the like. The plurality of client computing devices 104a-n may be associated with one or more users. A single user may use one or more of the plurality of client computing devices 104a-n to access the cloud network 102. The plurality of client computing devices 104a-n may travel to a variety of locations and use different networks to access the cloud network 102.

The service 112 may be configured to receive input from users. The users may be registered as users of the service 112 and may be users of the application 106 operating on client computing devices 104a-n. The user inputs may include user comments, user ratings, or user feedback associated with the content. The user inputs may include connection requests and user input data, such as text data, digital image data, or user content. The connection requests may comprise requests from the client computing devices 104a-n to connect to the service 112.

In an embodiment, a user may use the application 106 on a client computing device 104a-n to create content and upload the content to the cloud network 102. The client computing devices 104a-n may access an interface 108 of the application 106. The interface 108 may comprise an input element. For example, the input element may be configured to allow users to create the content. To create the content, the user may give the application 106 permission to access an image capture device, such as a camera, or a microphone of the client computing device 104a-n. After the user has created the content, the user may use the application 106 to upload the content to the cloud network 102 and/or to save the content locally to the user device 104a-n. When a user uploads the content to the cloud network 102, they may choose whether they want the content to be viewable by all other users of the application 106 or viewable by only a subset of the users of the application 106. The service 112 may store the uploaded content and any metadata associated with the content as content in one or more databases.

In an embodiment, a user may use the application 106 on a client computing device 104a-n to provide input on content. The client computing devices 104a-n may access an interface 108 of the application 106 that allows users to provide input associated with content. The interface 108 may comprise an input element. For example, the input element may be configured to receive input from a user, such as a rating, a comment, feedback, or “likes” associated with a particular content item. If the input is a comment, the application 106 may allow a user to set an emoji associated with his or her input. The application 106 may determine timing information for the input, such as when a user wrote a comment. The application 106 may send the input and associated metadata to the cloud network 102.

In an embodiment, the cloud network 102 comprises a classifier model 113. The classifier model 113 may be trained to categorize new observations into one of two classes. For example, one class may be a positive state (binary outcome of 1) and the other class may be a negative state (binary outcome of 0). The classifier model 113 may utilize one or more algorithms to perform binary classification, including one or more of logistic regression, k-nearest neighbors, decision trees, support vector machine, naive bayes, and/or the like.

The classifier model 113 may be used by the service 112 to make any type of classification. As one example, the classifier model 113 may be used to determine whether users of the service 112 (e.g., client computing devices 104a-n) will enjoy certain content recommendation. For example, with respect to a particular user, if the output of the classifier model 113 is a binary outcome of 1 (e.g., positive state), this output may indicate that the user will enjoy the content recommendation. Conversely, if the output of the classifier model 113 is a binary outcome of 0 (e.g., negative state), this may indicate that the user is not likely to enjoy the content recommendation. It should be appreciated that the classifier model 113 may be used to make any other type of classification.

As described above, it may be desirable to evaluate the performance of the classifier model 113. Evaluating the performance of the classifier model 113 may comprise calculating the AUC of the classifier model 113. As also described above, it may be desirable to determine the AUC of the classifier model 113 while protecting privacy of user data (e.g., without accessing any user data stored on the client computing devices 104a-n). For example, C₁, C₂, . . . , Cₙ may represent the client computing devices 104a-n. For each i∈{1, 2, . . . , n}, the client computing device Cᵢ holds nᵢ data (x_{i,1}, y_{i,1}), . . . (x_{i,n}_{ᵢ}, y_{i,n}_{ᵢ}), where x_{i,j}∈X and y_{i,j}∈{0, 1}. The service 112 and the client computing devices Cᵢ share a score function ƒ: X→ [symbol] . As described above, Equation 2 provides an empirical AUC estimate. AUCₑ represents the empirical AUC computed by Equation 2 with all training samples. AUCₑ may be approximated without sharing (x, y) between client computing devices 104a-n and the service 112.

In embodiments, the service 112 comprises an integration-based AUC model 115. To approximate AUCₑ without sharing (x, y) between client computing devices 104a-n and the service 112, an AUC computation based on integration (e.g., integration-based AUC computation) may be performed. The integration-based AUC computation may be performed, for example, by the integration-based AUC model 115.

Any distribution [symbol] over X also induces a distribution ƒ( [symbol] ) over [symbol] . The density of ƒ( [symbol] ) over [symbol] is given by p(z):=Pr_{x˜X} [ƒ(x)=z]. The probability density function (PDF) of ƒ( [symbol] ) is represented as p₊. The cumulative density function (CDF) of ƒ( [symbol] ) is represented as P₊. The probability density function (PDF) of ƒ( [symbol] ) is represented as p₋. The cumulative density function (CDF) of ƒ( [symbol] ) is represented as P₋. Then, Equation 1 can be re-written as:

P [symbol] [z₊>z₋]. Equation 3

Then, Equation 3 can be re-written as:

∫_{z-=-∞}^{+∞}(∫_{z-}^{∞}p₊(z₊)dz₊)p₋(z₋)dz₋. Equation 4

Finally, Equation 4 can be rewritten as:

∫_{z-=-∞}(1−P₊(z₋))p₋(z₋)dz₋. Equation 5

Thus, if P₊ (⋅) and p₋ (⋅) can be calculated, Equation 5 may be used to compute the AUC of the classifier model 113 without using raw data. For example, the integration-based AUC model 115 may use Equation 5 to compute the AUC of the classifier model 113 without using raw data. Equation 5 may be stored in the database(s) 114 as AUC integral data 121.

In embodiments, the service 112 comprises a normalizing flows model 117. The normalizing flows model 117 may be configured to estimate the two distributions P₊ (⋅) and p₋ (⋅) from raw data (e.g., user data stored on client computing devices 104a-n). To estimate P₊ (⋅) and p₋ (⋅) from user data stored on client computing devices 104a-n, normalizing flows may be utilized. Normalizing flows are generative models that are configured to produce tractable distributions where both sampling and density evaluation can be efficient and exact. For example, normalizing flows may be a machine learning model M that receives input x sampled from a distribution [symbol] ₁ and outputs M(x), which follows a target distribution of [symbol] ₂.

The machine learning model M may be represented by a neural network. The neural network may be trained by minimizing the Kullback-Leibler (KL) divergence. [symbol] ₁ may be the input distribution. [symbol] ₂ may be the uniform distribution. Thus, M(x) is the CDF of [symbol] ₁, and M′(x) is the PDF of [symbol] ₁. Accordingly, two neural networks M₊ and M₋ may be trained so that M₊ (x)=P₊ (x) and M₋ (x)=P₋ (x). Training M₊ so that M₊ (x)=P₊ (x) may comprise training M₊ on all positive samples from user data stored on client computing devices 104a-n. Training M₋ so that M₋ (x)=P₋ (x) may comprise training M₋ on all negative samples from user data stored on client computing devices 104a-n.

In embodiments, the service 112 comprises a FedAdam model 119a. The FedAdam model 119a may be configured to train the normalizing flows models M₊ and M₋. As the training data for training the normalizing flows models M₊ and M₋ is stored locally on the client computing devices 104a-n, the service 112 does not have direct access to the training data. To resolve this issue, a federated learning technique (e.g., “FedAdam”) may be utilized by the FedAdam model 119a.

Training of the normalizing flows models M₊ and M₋ may comprise multiple rounds of training. In each round of training, the FedAdam model 119a may distribute one or more of the normalizing flows models M₊ and M₋ to the client computing devices 104a-n. A corresponding model (e.g., model 119b) on the client computing devices 104a-n may be configured to receive the normalizing flows model M₊ and/or M₋ in each round. In each training round, the model 119b on the client computing devices 104a-n may update the normalizing flows model M₊ and/or M₋. For example, in each training round, each client computing device 104a-n (via the model 119b) may use locally stored data to obtain updates to the normalizing flows model M₊ and/or M₋. The client computing devices 104a-n (via the model 119b) may upload the updates to the service 112. The FedAdam model 119a may receive the updates from the client computing devices 104a-n. The FedAdam model 119a may compute moments of the model updates and aggregate them to prepare the normalizing flows model M₊ and/or M₋ for the next training round. FedAdam adaptively adjusts learning rate and can converge to a local optimal. The trained normalizing flows model M₊ and/or any data associated with the multiple rounds of training of normalizing flows model M₊ may be stored in the database(s) 114 as model A data 127. The trained normalizing flows model M₋ and/or any data associated with the multiple rounds of training of normalizing flows model M₋ may be stored in the database(s) 114 as model B data 129.

The normalizing flows model 117 may be configured to estimate the two distributions P₊ (⋅) and p₋ (⋅) using trained normalizing flows model M₊ and M₋. The normalizing flows model 117 may retrieve the trained models. For example, the normalizing flows model 117 may retrieve model A data 127 and model B data 129 from the database(s) 114. As M₊ was trained so that M₊ (x)=P₊ (x), the trained normalizing flows model M₊ may be used to estimate the distribution P₊ (⋅). As M₋ was trained so that M₋ (x)=P₋ (x), the trained normalizing flows model M₋ may be used to estimate the distribution P₋ (⋅). The distribution P₋ (⋅) may be utilized to estimate the distribution p₋ (⋅). For example, the distribution p₋ (⋅) may be estimated by computing the derivative of the distribution P₋ (⋅). The estimated distribution P₊ (⋅) may be stored in the database(s) 114 as CDF data 123. Likewise, the estimated distribution p₋ (⋅) may be stored in the database(s) 114 as PDF data 125.

The integration-based AUC model 115 may be configured to utilize the estimated distributions P₊ (⋅) and p₋ (⋅) to compute the AUC of the classifier model 113 without using raw data. For example, the integration-based AUC model 115 may utilize the estimated distributions P₊ (⋅) and p₋ (⋅) to calculate the value of Equation 5. The performance of the classifier model 113 may be determined based on the computed AUC (e.g., the value of Equation 5).

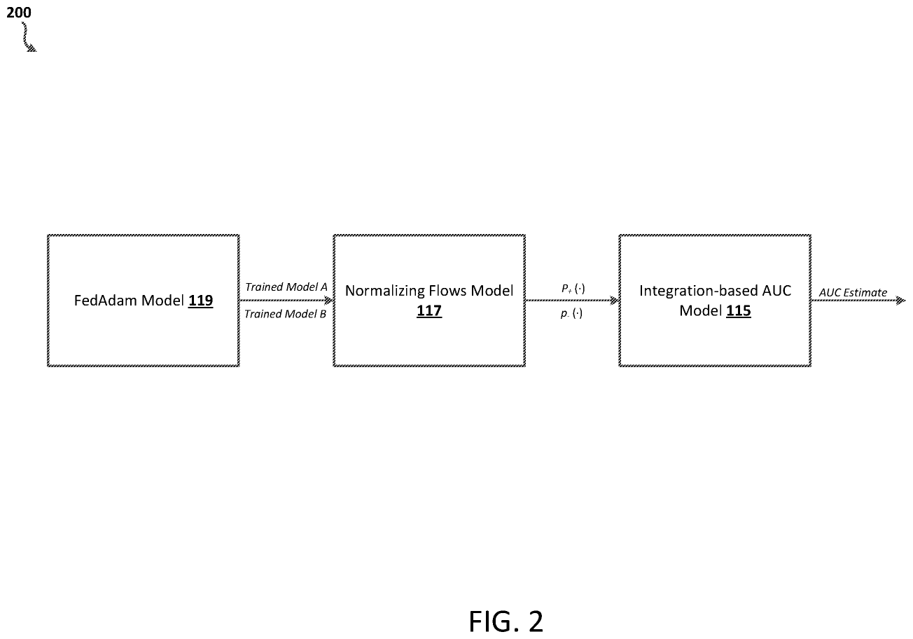

FIG. 2 shows an example framework 200 for determining classifier performance in accordance with the present disclosure. The framework 200 comprises the FedAdam model 119, the normalizing flows model 117, and the integration-based AUC model 115. The framework 200 may be utilized to determine the AUC of a classifier model (e.g., the classifier model 113). The FedAdam model 119 may be configured to train two machine learning models: model A (e.g., normalizing flows model M₊) and model B (e.g., normalizing flows model M₋). The model A may be trained on all positive samples from user data stored on client computing devices (e.g., client computing devices 104a-n). The model B may be trained on all negative samples from user data stored on client computing devices.

The model A and model B may be trained by FedAdam, during which only model updates, rather than raw data, are exchanged between a central server (e.g., service 112) and client computing devices. During the training process, the central server does not access the user data stored on the client computing devices, which meets compliance requirements. The trained model A and trained model B may be sent to and/or retrieved by the normalizing flows model 117.

The normalizing flows model 117 may receive the trained model A and trained model B. The normalizing flows model 117 may be configured to estimate P₊ (⋅) (e.g., the CDF of ƒ( [symbol] ₊)) and p₋ (⋅) (e.g., the PDF of ƒ( [symbol] ₋)). The normalizing flows model 117 may utilize the trained model A to determine P₊ (⋅) The normalizing flows model 117 may utilize the trained model B to determine p₋ (⋅). The P₊ (⋅) and p₋ (⋅) estimates may be sent to and/or retrieved by the integration-based AUC model 115.

The integration-based AUC model 115 may receive the P₊ (⋅) and p₋ (⋅) estimates. The integration-based AUC model 115 may utilize the P₊ (⋅) and p₋ (⋅) estimates to determine (e.g., estimate) the AUC of the classifier model. For example, the integration-based AUC model 115 may utilize the P₊ (⋅) and p₋ (⋅) estimates to calculate a value of Equation 5. The value of Equation 5 may be equal to the AUC of the classifier model. The performance of the classifier model may be determined based on the computed AUC.

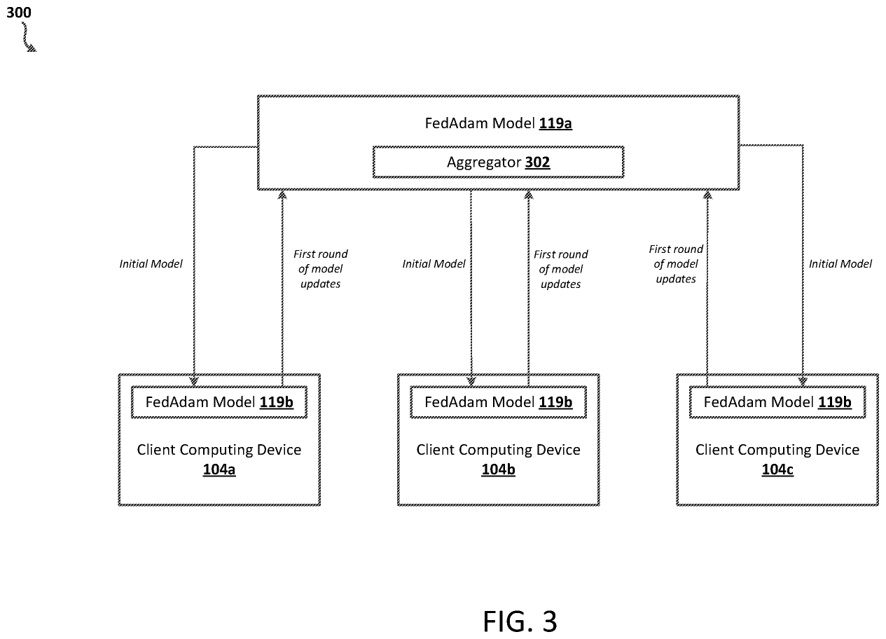

FIG. 3 shows an example framework 300 for training a machine learning model in accordance with the present disclosure. The framework 300 comprises the FedAdam model 119a. The FedAdam model 119a may be located at a central server (e.g., service 112). The framework 300 comprises a first subset (e.g., 104a-c) of the plurality of client computing devices 104a-n. The first subset of client computing devices 104a-c may each comprise a model 119b. The model 119b may correspond to or communicate with the FedAdam model 119a. The FedAdam model 119a may be configured to train one or more machine learning models. For example, the FedAdam model 119a may be configured to train normalizing flows model M₊ and normalizing flows model M₋.

Training of the normalizing flows models M₊ and M₋ may comprise multiple rounds of training. The first (e.g., initial) round of training is depicted by the example of FIG. 3. In the first round of training, the FedAdam model 119a may distribute the initial normalizing flows model M₊ and/or M₋ to the first subset of client computing devices 104a-c. The model 119b on first subset of client computing devices 104a-c may receive the initial normalizing flows model M₊ and/or M₋. In response to receiving the initial normalizing flows model M₊ and/or M₋, the model 119b on each of the first subset of client computing devices 104a-c may update the initial normalizing flows model M₊ and/or M₋ using data stored locally on that particular client computing device.

The first subset of client computing devices 104a-c (via the model 119b) may upload (e.g., send) the updates to the initial model(s) to the FedAdam model 119a. The FedAdam model 119a may receive the updates from first subset of client computing devices 104a-c. The FedAdam model 119a may compute moments of the model updates. An aggregator 302 of the FedAdam model 119a may aggregate the moments of the model updates to prepare the normalizing flows model M₊ and/or M₋ for the second training round. The updated normalizing flows model M₊ and/or M₋ may be further trained in a second round of training.

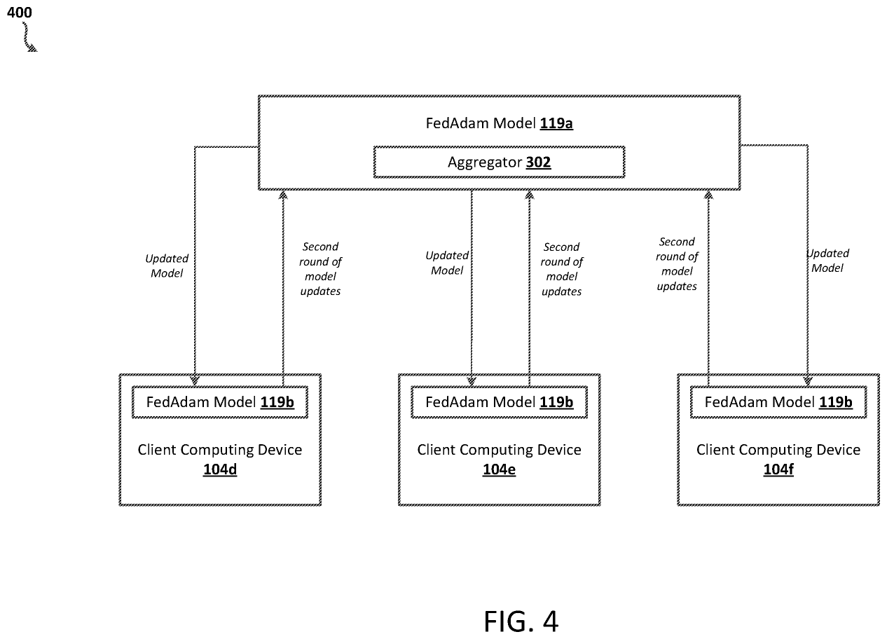

An exemplary second training round is depicted by the framework 400 of FIG. 4. In the second round of training, the FedAdam model 119a may distribute the update normalizing flows model M₊ and/or M₋ to a second subset of client computing devices 104d-f. The second subset of client computing devices 104d-f may comprise all, some, or none of the same client computing devices 104a-c used in the first training round. The model 119b on the second subset of client computing devices 104d-f may receive the updated normalizing flows model M₊ and/or M₋. In response to receiving the updated normalizing flows model M₊ and/or M₋, the model 119b on each of the second subset of client computing devices 104d-f may further update the updated normalizing flows model M₊ and/or M₋ using data stored locally on that particular client computing device.

The second subset of client computing devices 104d-f (via the model 119b) may upload (e.g., send) the updates to the updated model(s) to the FedAdam model 119a. The FedAdam model 119a may receive the updates from the second subset of client computing devices 104d-f. The FedAdam model 119a may compute moments of the model updates. The aggregator 302 of the FedAdam model 119a may aggregate the moments of the model updates to prepare the normalizing flows model M₊ and/or M₋ for the third training round. The further updated normalizing flows model M₊ and/or M₋ may be further trained in a third, fourth, fifth, etc. round of training.

Any quantity of training rounds may be performed. For example, ten or more training rounds may be performed. In the setting of online learning, instead of static training data, the training data comes from a data stream and varies by time. As FedAdam proceeds in rounds, it is suitable to use different training data in different training rounds. Hence the techniques described herein are compatible with online learning.

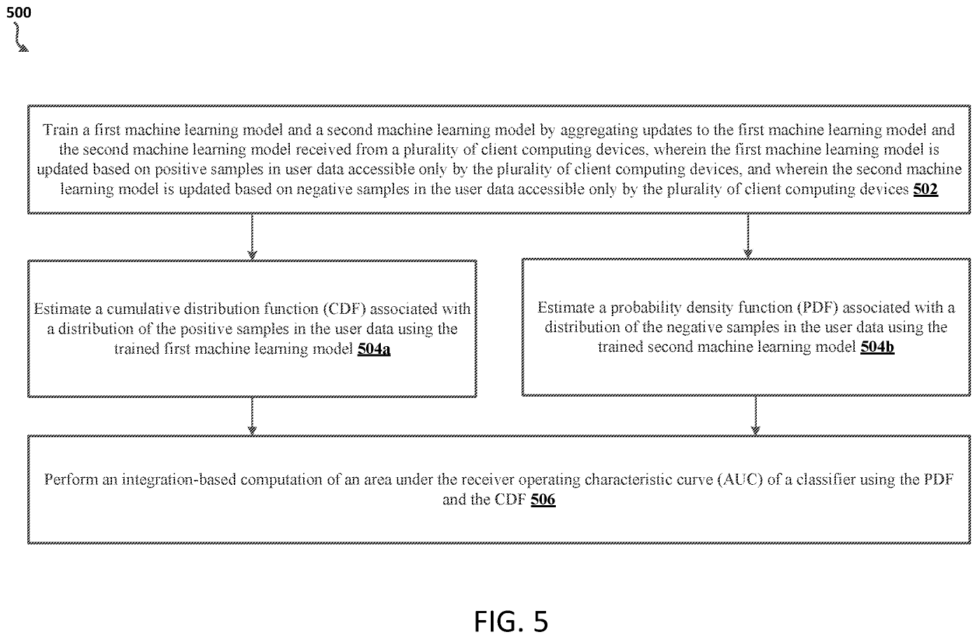

FIG. 5 illustrates an example process 500 for determining AUC while protecting user data privacy. For example, the service 112 may perform the process 500 to determining the AUC of a classifier (e.g., binary classifier). Although depicted as a sequence of operations in FIG. 5, those of ordinary skill in the art will appreciate that various embodiments may add, remove, reorder, or modify the depicted operations.

At 502, a first machine learning model (e.g., M₊) and a second machine learning model (M₋) may be trained. The first machine learning model and the second machine learning model may be trained by aggregating updates to the first machine learning model and the second machine learning model. The updates to the first machine learning model and the second machine learning model may be received from a plurality of client computing devices.

The first machine learning model may be updated based on positive samples in user data accessible only by the plurality of client computing devices. The second machine learning model may be updated based on negative samples in the user data accessible only by the plurality of client computing devices. For example, the first machine learning model may be trained so that the first machine learning model is equal to P₊ (x), where the CDF of ƒ( [symbol] ₊) is represented as P₊. The second machine learning model may be trained so that the second machine learning model is equal to P₋ (x), where the CDF of ƒ( [symbol] ₋) is represented as P₋.

At 504a, a CDF associated with a distribution of the positive samples in the user data may be estimated using the trained first machine learning model. As described above, the first machine learning model may be trained so that the first machine learning model is equal to P₊ (x), where the CDF of ƒ( [symbol] P₊) is represented as P₊. Thus, the first machine learning model may be utilized to determine P₊ (⋅). At 504b, a PDF associated with a distribution of the negative samples in the user data may be estimated using the trained second machine learning model. As described above, the second machine learning model may be trained so that the second machine learning model is equal to P₋ (x), where the CDF of ƒ( [symbol] ₋) is represented as P₋. Thus, the second machine learning model may be utilized to determine P₋ (⋅). Then, P₋ (⋅) may be utilized to determine a distribution p₋ (⋅), where the PDF of ƒ( [symbol] ₋) is represented as p₋. For example, the distribution p₋ (⋅) may be estimated by computing the derivative of the distribution P₋ (⋅).

At 506, an integration-based computation of an area under the receiver operating characteristic curve (AUC) of a classifier may be performed. The integration-based computation of the AUC of the classifier may be performed using the PDF and the CDF estimated at 504a and 504b. Thus, the method 500 may be utilized to compute the AUC of the classifier model without using user data stored on the plurality of client computing devices.

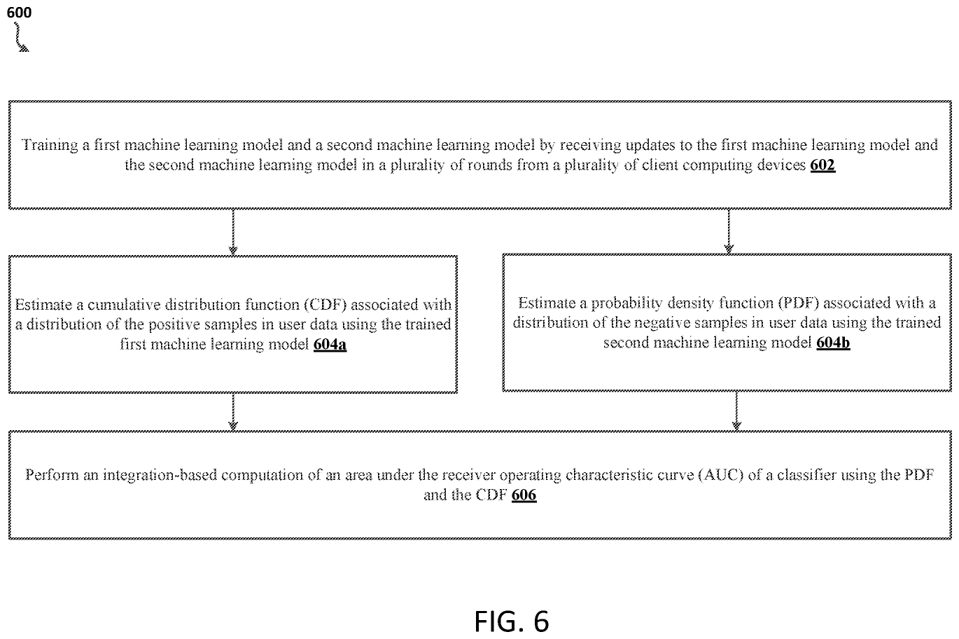

FIG. 6 illustrates an example process 600 for determining AUC while protecting user data privacy. For example, the service 112 may perform the process 600 to determining the AUC of a classifier (e.g., binary classifier). Although depicted as a sequence of operations in FIG. 6, those of ordinary skill in the art will appreciate that various embodiments may add, remove, reorder, or modify the depicted operations.

At 602, a first machine learning model (e.g., M₊) and a second machine learning model (M₋) may be trained. The first machine learning model and the second machine learning model may be trained by receiving updates to the first machine learning model and the second machine learning model in a plurality of rounds from a plurality of client computing devices. The first machine learning model may be updated based on positive samples in user data accessible only by the plurality of client computing devices. The second machine learning model may be updated based on negative samples in the user data accessible only by the plurality of client computing devices. For example, the first machine learning model may be trained in a plurality of rounds so that the first machine learning model is equal to P₊ (x), where the CDF of ƒ( [symbol] ₊) is represented as P₊. The second machine learning model may be trained in a plurality of rounds so that the second machine learning model is equal to P₋ (x), where the CDF of ƒ( [symbol] ₋) is represented as P₋.

At 604a, a CDF associated with a distribution of the positive samples in the user data may be estimated using the trained first machine learning model. As described above, the first machine learning model may be trained so that the first machine learning model is equal to P₊ (x), where the CDF of ƒ( [symbol] ₊) is represented as P₊. Thus, the first machine learning model may be utilized to determine P₊ ( ). At 604b, a PDF associated with a distribution of the negative samples in the user data may be estimated using the trained second machine learning model. As described above, the second machine learning model may be trained so that the second machine learning model is equal to P₋ (x), where the CDF of ƒ( [symbol] ₋) is represented as P₋. Thus, the second machine learning model may be utilized to determine P₋ (⋅). Then, P₋ (⋅) may be utilized to determine a distribution p₋ (⋅), where the PDF of ƒ( [symbol] ₋) is represented as p₋. For example, the distribution p₋ (⋅) may be estimated by computing the derivative of the distribution P₋ (⋅).

At 606, an integration-based computation of an area under the receiver operating characteristic curve (AUC) of a classifier may be performed. The integration-based computation of the AUC of the classifier may be performed using the PDF and the CDF estimated at 604a and 604b. Thus, the method 600 may be utilized to compute the AUC of the classifier model without using user data stored on the plurality of client computing devices.

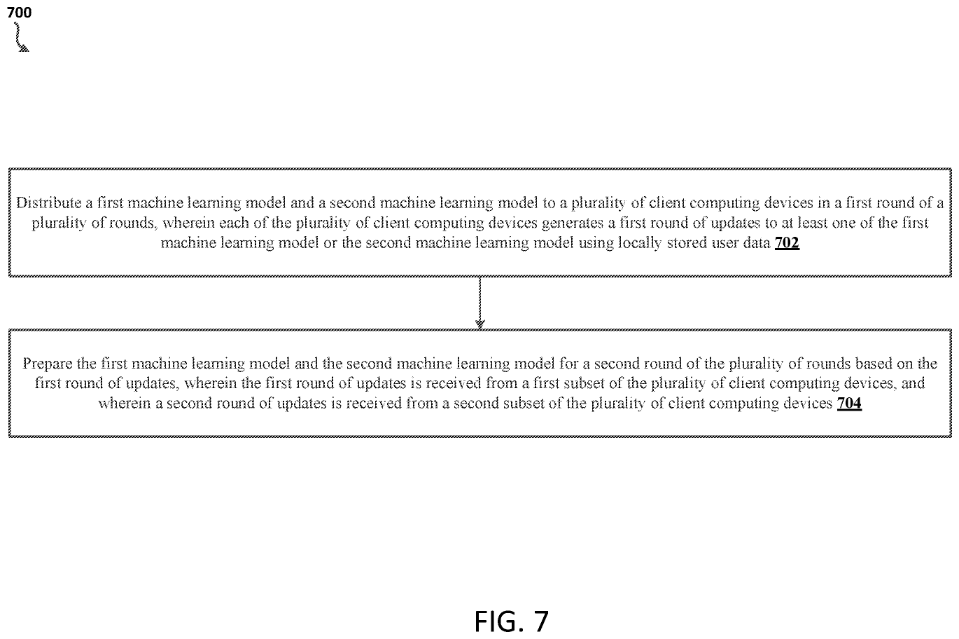

FIG. 7 illustrates an example process 700 for determining AUC while protecting user data privacy. For example, the service 112 may perform the process 700 to determining the AUC of a classifier (e.g., binary classifier). Although depicted as a sequence of operations in FIG. 7, those of ordinary skill in the art will appreciate that various embodiments may add, remove, reorder, or modify the depicted operations.

Training of the normalizing flows models M₊ and M₋ may comprise multiple rounds of training. At 702, a first machine learning model (e.g., M₊) and the second machine learning model (e.g., M₋) may be distributed to at least a first subset of the plurality of client computing devices in a first round of a plurality of rounds. Each of the at least the first subset of client computing devices may generate a first round of updates to at least one of the first machine learning model or the second machine learning model using locally stored user data. The at least the first subset of client computing devices may upload (e.g., send) the updates to first machine learning model and/or the second machine learning model to a central server (e.g., service 112).

The central server may receive the updates from at least the first subset of client computing devices. At 704, the first machine learning model and the second machine learning model may be prepared for a second round of the plurality of rounds based on the first round of updates. For example, moments of the model updates may be computed. The moments of the model updates may be aggregated to prepare the first machine learning model and/or the second machine learning model for the second training round. The prepared first machine learning model and/or the second machine learning model may be further trained in a second round of training. A second round of updates may be received in the second round of training from a second subset of the plurality of client computing devices. The second subset may be different from the first subset of the plurality of client computing devices.

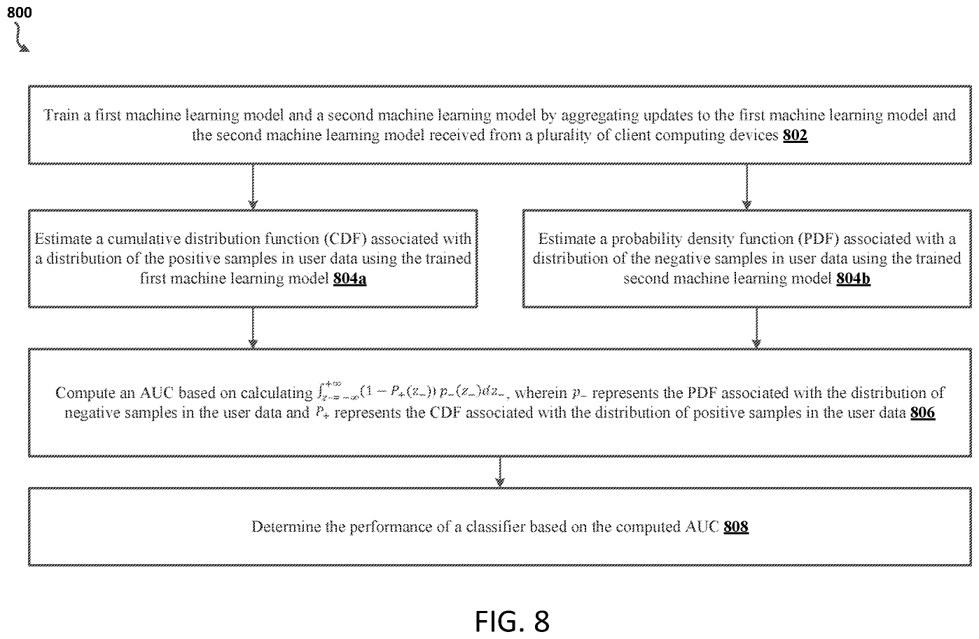

FIG. 8 illustrates an example process 800 for determining AUC while protecting user data privacy. For example, the service 112 may perform the process 800 to determining the AUC of a classifier (e.g., binary classifier). Although depicted as a sequence of operations in FIG. 8, those of ordinary skill in the art will appreciate that various embodiments may add, remove, reorder, or modify the depicted operations.

At 802, a first machine learning model (e.g., M₊) and a second machine learning model (M₋) may be trained. The first machine learning model and the second machine learning model may be trained by aggregating updates to the first machine learning model and the second machine learning model. The updates to the first machine learning model and the second machine learning model may be received from a plurality of client computing devices.

The first machine learning model may be updated based on positive samples in user data accessible only by the plurality of client computing devices. The second machine learning model may be updated based on negative samples in the user data accessible only by the plurality of client computing devices. For example, the first machine learning model may be trained so that the first machine learning model is equal to P₊ (x), where the CDF of ƒ( [symbol] ₊) is represented as P₊. The second machine learning model may be trained so that the second machine learning model is equal to P₋ (x), where the CDF of ƒ( [symbol] ₋) is represented as P₋.

At 804a, a CDF associated with a distribution of the positive samples in the user data may be estimated using the trained first machine learning model. As described above, the first machine learning model may be trained so that the first machine learning model is equal to P₊ (x), where the CDF of ƒ( [symbol] ₊) is represented as P₊. Thus, the first machine learning model may be utilized to determine P₊ (⋅). At 804b, a PDF associated with a distribution of the negative samples in the user data may be estimated using the trained second machine learning model. As described above, the second machine learning model may be trained so that the second machine learning model is equal to P₋ (x), where the CDF of ƒ( [symbol] ₋) is represented as P₋. Thus, the second machine learning model may be utilized to determine P₋ (⋅). Then, P₋ (⋅) may be utilized to determine a distribution p₋ (⋅), where the PDF of ƒ( [symbol] ₋) is represented as p₋. For example, the distribution p₋ (⋅) may be estimated by computing the derivative of the distribution P₋ (⋅).

At 806, an AUC may be computed. The AUC may be computed based on calculating the value of Equation 5. The value of Equation 5 may be calculated using the distribution P₊ (⋅) and the distribution p₋ (⋅). As described above, p₋ (⋅) represents a PDF associated with the distribution of negative samples in the user data and P₊ (⋅) represents a CDF associated with the distribution of positive samples in the user data. Thus, the method 800 may be utilized to compute the AUC of the classifier model without using user data stored on the plurality of client computing devices. At 808, the performance of a classifier may be determined based on the computed AUC.

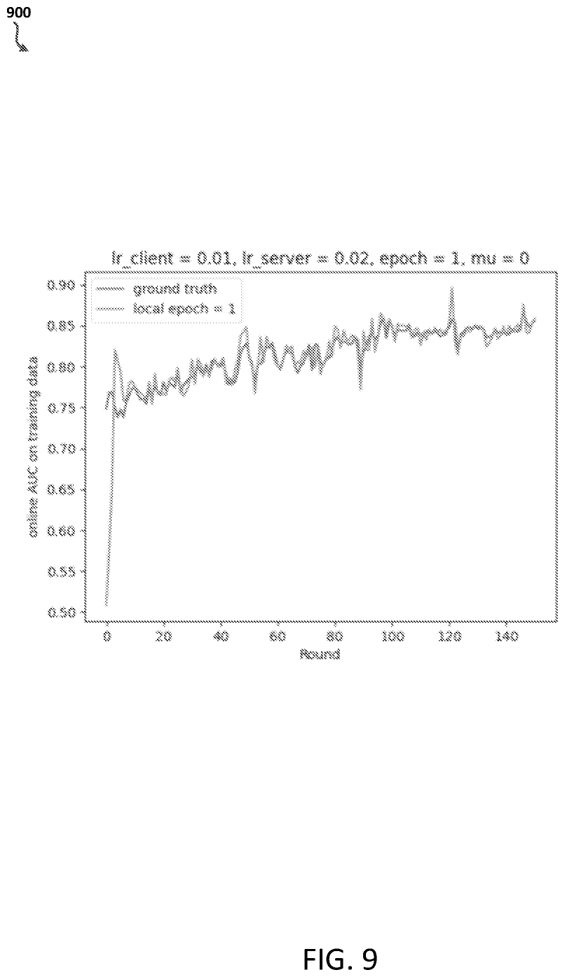

FIG. 9 illustrates a graph 900 depicting the performance of the techniques described herein. The graph 900 includes a first line associated with a set of ground truth data. The ground truth data may have been collected for experimental purposes. The first line depicts how the value of a prediction (e.g., score) function changes with time (over the course of many rounds). The graph 900 includes a second line depicting how the value of a prediction (e.g., score) function generated using the techniques described herein changes with time (over the course of many rounds). As shown by the graph 900, the first line and second line are similar (e.g., substantially the same). Thus, the techniques described here are effective in determining the performance of a classifier.

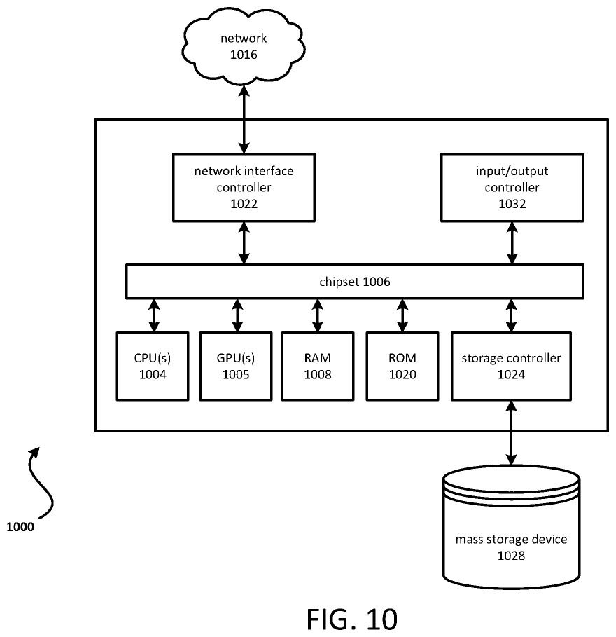

FIG. 10 illustrates a computing device that may be used in various aspects, such as the services, networks, models, and/or devices depicted in FIG. 1. With regard to the example architecture of FIG. 1, the cloud network (and any of its components), the client computing devices, and/or the network may each be implemented by one or more instance of a computing device 1000 of FIG. 10. The computer architecture shown in FIG. 10 shows a conventional server computer, workstation, desktop computer, laptop, tablet, network appliance, PDA, e-reader, digital cellular phone, or other computing node, and may be utilized to execute any aspects of the computers described herein, such as to implement the methods described herein.

The computing device 1000 may include a baseboard, or “motherboard,” which is a printed circuit board to which a multitude of components or devices may be connected by way of a system bus or other electrical communication paths. One or more central processing units (CPUs) 1004 may operate in conjunction with a chipset 1006. The CPU(s) 1004 may be standard programmable processors that perform arithmetic and logical operations necessary for the operation of the computing device 1000.

The CPU(s) 1004 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 1004 may be augmented with or replaced by other processing units, such as GPU(s) 1005. The GPU(s) 1005 may comprise processing units specialized for but not necessarily limited to highly parallel computations, such as graphics and other visualization-related processing.

A chipset 1006 may provide an interface between the CPU(s) 1004 and the remainder of the components and devices on the baseboard. The chipset 1006 may provide an interface to a random-access memory (RAM) 1008 used as the main memory in the computing device 1000. The chipset 1006 may further provide an interface to a computer-readable storage medium, such as a read-only memory (ROM) 1020 or non-volatile RAM (NVRAM) (not shown), for storing basic routines that may help to start up the computing device 1000 and to transfer information between the various components and devices. ROM 1020 or NVRAM may also store other software components necessary for the operation of the computing device 1000 in accordance with the aspects described herein.

The computing device 1000 may operate in a networked environment using logical connections to remote computing nodes and computer systems through local area network (LAN). The chipset 1006 may include functionality for providing network connectivity through a network interface controller (NIC) 1022, such as a gigabit Ethernet adapter. A NIC 1022 may be capable of connecting the computing device 1000 to other computing nodes over a network 1016. It should be appreciated that multiple NICs 1022 may be present in the computing device 1000, connecting the computing device to other types of networks and remote computer systems.

The computing device 1000 may be connected to a mass storage device 1028 that provides non-volatile storage for the computer. The mass storage device 1028 may store system programs, application programs, other program modules, and data, which have been described in greater detail herein. The mass storage device 1028 may be connected to the computing device 1000 through a storage controller 1024 connected to the chipset 1006. The mass storage device 1028 may consist of one or more physical storage units. The mass storage device 1028 may comprise a management component. A storage controller 1024 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1000 may store data on the mass storage device 1028 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 1028 is characterized as primary or secondary storage and the like.

For example, the computing device 1000 may store information to the mass storage device 1028 by issuing instructions through a storage controller 1024 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1000 may further read information from the mass storage device 1028 by detecting the physical states or characteristics of one or more particular locations within the physical storage units.

In addition to the mass storage device 1028 described above, the computing device 1000 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 1000.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 1028 depicted in FIG. 10, may store an operating system utilized to control the operation of the computing device 1000. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 1028 may store other system or application programs and data utilized by the computing device 1000.

The mass storage device 1028 or other computer-readable storage media may also be encoded with computer-executable instructions, which, when loaded into the computing device 1000, transforms the computing device from a general-purpose computing system into a special-purpose computer capable of implementing the aspects described herein. These computer-executable instructions transform the computing device 1000 by specifying how the CPU(s) 1004 transition between states, as described above. The computing device 1000 may have access to computer-readable storage media storing computer-executable instructions, which, when executed by the computing device 1000, may perform the methods described herein.

A computing device, such as the computing device 1000 depicted in FIG. 10, may also include an input/output controller 1032 for receiving and processing input from a number of input devices, such as a keyboard, a mouse, a touchpad, a touch screen, an electronic stylus, or other type of input device. Similarly, an input/output controller 1032 may provide output to a display, such as a computer monitor, a flat-panel display, a digital projector, a printer, a plotter, or other type of output device. It will be appreciated that the computing device 1000 may not include all of the components shown in FIG. 10, may include other components that are not explicitly shown in FIG. 10, or may utilize an architecture completely different than that shown in FIG. 10.

As described herein, a computing device may be a physical computing device, such as the computing device 1000 of FIG. 10. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method for determining performance of a classifier, the method comprising:
training a first machine learning model and a second machine learning model by aggregating updates to the first machine learning model and the second machine learning model received from a plurality of client computing devices, wherein the first machine learning model is updated based on positive samples in user data accessible only by the plurality of client computing devices, and wherein the second machine learning model is updated based on negative samples in the user data accessible only by the plurality of client computing devices;
estimating a cumulative distribution function (CDF) associated with a distribution of the positive samples in the user data using the trained first machine learning model;
estimating a probability density function (PDF) associated with a distribution of the negative samples in the user data using the trained second machine learning model; and
performing an integration-based computation of an area under the receiver operating characteristic curve (AUC) of the classifier using the PDF and the CDF.

2. The method of claim 1, wherein the training the first machine learning model and the second machine learning model comprises receiving the updates in a plurality of rounds from the plurality of client computing devices.

3. The method of claim 2, further comprising:
distributing the first machine learning model and the second machine learning model to the plurality of client computing devices in a first round of the plurality of rounds, wherein each of the plurality of client computing devices generates a first round of updates to at least one of the first machine learning model or the second machine learning model using locally stored user data.

4. The method of claim 3, further comprising:
preparing the first machine learning model and the second machine learning model for a second round of the plurality of rounds based on the first round of updates.

5. The method of claim 4, wherein the first round of updates is received from a first subset of the plurality of client computing devices, and wherein a second round of updates is received from a second subset of the plurality of client computing devices.

6. The method of claim 1, further comprising:
computing the AUC based on calculating ∫_{z-=-∞}^{+∞}(1−P₊(z₋)) p₋(z₋)dz₋, wherein p₋ represents the PDF associated with the distribution of negative samples in the user data, and P₊ represents the CDF associated with the distribution of positive samples in the user data.

7. The method of claim 6, further comprising:
determining the performance of the classifier based on the computed AUC.

8. A system, comprising:
at least one processor; and
at least one memory comprising computer-readable instructions that upon execution by the at least one processor cause the computing device to perform operations comprising:
training a first machine learning model and a second machine learning model by aggregating updates to the first machine learning model and the second machine learning model received from a plurality of client computing devices, wherein the first machine learning model is updated based on positive samples in user data accessible only by the plurality of client computing devices, and wherein the second machine learning model is updated based on negative samples in the user data accessible only by the plurality of client computing devices;
estimating a cumulative distribution function (CDF) associated with a distribution of the positive samples in the user data using the trained first machine learning model;
estimating a probability density function (PDF) associated with a distribution of the negative samples in the user data using the trained second machine learning model; and
performing an integration-based computation of an area under the receiver operating characteristic curve (AUC) of the classifier using the PDF and the CDF.

9. The system of claim 8, wherein the training the first machine learning model and the second machine learning model comprises receiving the updates in a plurality of rounds from the plurality of client computing devices.

10. The system of claim 9, the operations further comprising:
distributing the first machine learning model and the second machine learning model to the plurality of client computing devices in a first round of the plurality of rounds, wherein each of the plurality of client computing devices generates a first round of updates to at least one of the first machine learning model or the second machine learning model using locally stored user data.

11. The system of claim 10, the operations further comprising:
preparing the first machine learning model and the second machine learning model for a second round of the plurality of rounds based on the first round of updates.

12. The system of claim 11, wherein the first round of updates is received from a first subset of the plurality of client computing devices, and wherein a second round of updates is received from a second subset of the plurality of client computing devices.

13. The system of claim 8, the operations further comprising:
computing the AUC based on calculating ∫_{z-=-∞}^{+∞}(1−P₊(z₋)) p₋(z₋)dz₋, wherein p₋ represents the PDF associated with the distribution of negative samples in the user data and P₊ represents the CDF associated with the distribution of positive samples in the user data.

14. The system of claim 13, the operations further comprising:
determining the performance of the classifier based on the computed AUC.

15. A non-transitory computer-readable storage medium, storing computer-readable instructions that upon execution by a processor cause the processor to implement operations, the operation comprising:
training a first machine learning model and a second machine learning model by aggregating updates to the first machine learning model and the second machine learning model received from a plurality of client computing devices, wherein the first machine learning model is updated based on positive samples in user data accessible only by the plurality of client computing devices, and wherein the second machine learning model is updated based on negative samples in the user data accessible only by the plurality of client computing devices;
estimating a cumulative distribution function (CDF) associated with a distribution of the positive samples in the user data using the trained first machine learning model;
estimating a probability density function (PDF) associated with a distribution of the negative samples in the user data using the trained second machine learning model; and
performing an integration-based computation of an area under the receiver operating characteristic curve (AUC) of the classifier using the PDF and the CDF.

16. The non-transitory computer-readable storage medium of claim 15, wherein the training the first machine learning model and the second machine learning model comprises receiving the updates in a plurality of rounds from the plurality of client computing devices.

17. The non-transitory computer-readable storage medium of claim 16, the operations further comprising:
distributing the first machine learning model and the second machine learning model to the plurality of client computing devices in a first round of the plurality of rounds, wherein each of the plurality of client computing devices generates a first round of updates to at least one of the first machine learning model or the second machine learning model using locally stored user data.

18. The non-transitory computer-readable storage medium of claim 17, the operations further comprising:
preparing the first machine learning model and the second machine learning model for a second round of the plurality of rounds based on the first round of updates.

19. The non-transitory computer-readable storage medium of claim 18, wherein the first round of updates is received from a first subset of the plurality of client computing devices, and wherein a second round of updates is received from a second subset of the plurality of client computing devices.

20. The non-transitory computer-readable storage medium of claim 15, the operations further comprising:
computing the AUC based on calculating ∫_{z-=-∞}^{+∞}(1−P₊(z₋)) p₋(z₋)dz₋, wherein p₋ represents the PDF associated with the distribution of negative samples in the user data and P₊ represents the CDF associated with the distribution of positive samples in the user data.
